(19) United States
(12) Patent Application Publication
(10) Pub. No.: US 2015/0063207 A1
(43) Pub. Date: Mar. 5, 2015

(54) RECEPTION DEVICE, POST-DECODING LIKELIHOOD CALCULATION DEVICE, AND RECEPTION METHOD

(71) Applicant: Sharp Kabushiki Kaisha, Osaka-shi, Osaka (JP)

(72) Inventors: Osamu Nakamura, Osaka-shi (JP); Hiroki Takahashi, Osaka-shi (JP); Jungo Goto, Osaka-shi (JP); Kazunari Yokomakura, Osaka-shi (JP); Yasuhiro Hamaguchi, Osaka-shi (JP)

(21) Appl. No.: 14/386,886

(22) PCT Filed: Mar. 12, 2013
(86) PCT No.: PCT/JP2013/056760

§ 371 Date: Sep. 22, 2014

(30) Foreign Application Priority Data
Mar. 23, 2012 (JP) 2012-068375

(51) Int. Cl. H04W 24/02; H04L 27/26; H04B 1/10

(52) U.S. Cl. CPC H04W 24/02; H04B 1/10; H04L 27/2649
USPC 370/328

(57) ABSTRACT

A reception device that can transmit, at a good error rate, information on which error correction has been performed by a block code is provided. The reception device includes a demodulating unit that generates a demodulation result of each coded bit for the signal received from the transmission device, a decoding unit that calculates a post-decoding likelihood of the block code based on the demodulation result, a symbol replica generating unit that generates a symbol replica based on the post-decoding likelihood, and a cancelling unit that cancels interference from the received signal by using the symbol replica.

### TECHNICAL FIELD

The present invention relates to reception devices, post-decoding likelihood calculation devices, and reception methods.

### BACKGROUND ART

Long Term Evolution (LTE) Release 8 (Rel-8) which is a radio communication system standardized by the 3rd Generation Partnership Project (3GPP) can perform communication by using a band of up to 20 MHz.

An uplink (communication from a mobile station to a base station) of LTE is formed of the physical uplink shared channel (PUSCH) for transmitting data, the sounding reference signal (SRS) used by the base station to grasp the channel state between the base station and the mobile station, and the physical uplink control channel (PUCCH) for transmitting control information. In Rel-8, any one of the above-described signals is transmitted with one transmission timing.

In the PUCCH, each user equipment (UE, a mobile station) transmits information to be transmitted by spreading the information in a frequency domain by using a different spreading code for each UE. Here, although the transmit signals of the UEs share the same resource, since an orthogonal code is used for spread of each UE, in a frequency non-selective fading environment, it is possible to perform communication in which no interference occurs. However, in a frequency selective fading environment, the transmission performance is undesirably degraded significantly due to interference from other UEs associated with the disordered orthogonality.

Thus, in LTE-Advanced (LTE-A) obtained by advancing LTE, the spatially orthogonal resource transmit diversity (SORTD) in which a plurality of spreading codes are assigned to a UE and the UE spreads the same information by using different spreading codes and transmits the information from different transmit antennas is adopted (see NPL 1). In an enhanced Node B (eNB, a base station), by performing inverse spread by the spreading codes and performing combining, it is possible to obtain the transmit antenna diversity effect, which makes it possible to improve the performance.

Moreover, as a method for obtaining good transmission performance, there is a method of performing iterative processing (turbo-equalization, successive interference cancellation (SIC), parallel interference cancellation (PIC), and so forth) on an error-correction coded signal by a code for calculating a likelihood at the time of decoding, such as a turbo code or a low-density parity-check code (LDPC), by using the likelihood in reception processing (for example, NPL 2).

### CITATION LIST

### Non Patent Literature

NPL 1: 3GPP, “Radio Resource Control (RRC); Protocol specification (Release 10)”, 3GPP TS 36.331 V10.0.0
NPL 2: D. Reynolds and X. Wang, “Low complexity turbo-equalization for diversity channels,” Signal Processing, vol. 81, no. 5, pp. 989-995, May 2001.

### SUMMARY OF INVENTION

### Technical Problem

In LTE and LTE-A defined in the above-described NPL 1 and so forth, as for the PUCCH, a plurality of transmission methods are defined depending on the type of information to be transmitted. In particular, in PUCCH format 2 or the like, as an error correction code, a block code called a Reed-Muller code is used. Here, since a block code such as the Reed-Muller code is an error correction code that does not calculate a likelihood at the time of decoding, iterative processing, for example, which is performed in NPL 2 cannot be performed, which sometimes makes it impossible to obtain a sufficient error rate.

The present invention has been made in view of these circumstances, and an object thereof is to provide a reception device that can transmit, at a good error rate, information on which error correction has been performed by a block code, a post-decoding likelihood calculation device, and a reception method.

### Solution to Problem

(1) This invention has been made to solve the above-described problem, and an aspect of the present invention is directed to a reception device that receives a signal from a transmission device transmitting a coded bit on which error correction has been performed by a block code, the reception device including: a demodulating unit that generates a demodulation result of each coded bit for the signal received from the transmission device; a decoding unit that calculates a post-decoding likelihood of the block code based on the demodulation result; a symbol replica generating unit that generates a symbol replica based on the post-decoding likelihood; and a cancelling unit that cancels interference from the received signal by using the symbol replica.

(2) Moreover, another aspect of the present invention is directed to the above-described reception device and is characterized in that, in calculating the post-decoding likelihood of each coded bit, the decoding unit uses, of candidates for a coded bit sequence based on the block code, only a candidate whose coded bit is 1, the candidate closest to a sequence of the pre-decoding likelihood, and a candidate whose coded bit is 0, the candidate closest to the sequence of the pre-decoding likelihood.

(3) Furthermore, still another aspect of the present invention is directed to the above-described reception device and is characterized in that the decoding unit uses thermal noise as noise in calculating the post-decoding likelihood of each coded bit.

(4) In addition, yet another aspect of the present invention is directed to the above-described reception device and is characterized in that the decoding unit uses power which is a combination of thermal noise power and interference power in calculating the post-decoding likelihood of each coded bit.

(5) Moreover, yet another aspect of the present invention is directed to a post-decoding likelihood calculation device that calculates a post-decoding likelihood of a coded bit coded by a block code, wherein the post-decoding likelihood calculation device calculates the post-decoding likelihood by using, of candidates for a coded bit sequence based on the block code, only a candidate whose coded bit is 1, the candidate closest to a sequence of the pre-decoding likelihood, and a candidate whose coded bit is 0, the candidate closest to the sequence of the pre-decoding likelihood.

(6) Furthermore, yet another aspect of the present invention is directed to a reception method for receiving a signal from a transmission device that transmits a coded bit on which error correction has been performed by a block code, the method including: a demodulation process of calculating a pre-decoding likelihood of the coded bit based on the signal received from the transmission device; a decoding process of calculating a post-decoding likelihood of the block code based on the pre-decoding likelihood; a symbol replica generation process of generating a symbol replica based on the post-decoding likelihood; and a cancellation process of canceling interference from the received signal by using the symbol replica.

### Advantageous Effects of Invention

According to this invention, it is possible to transmit, at a good error rate, information on which error correction has been performed by a block code.

### BRIEF DESCRIPTION OF DRAWINGS

FIG. 1 is a schematic block diagram depicting the configuration of a radio communication system 10 in a first embodiment of the present invention.

FIG. 2 is a diagram depicting an example of the transmission frame configuration of the PUCCH in the embodiment.

FIG. 3 is a schematic block diagram depicting the configuration of a terminal device 100 in the embodiment.

FIG. 4 is a diagram depicting a matrix which is used for Reed-Muller coding in the embodiment.

FIG. 5 is a diagram depicting φ(n) in the embodiment.

FIG. 6 is a schematic block diagram depicting the configuration of an SC-FDMA signal generating unit 106 in the embodiment.

FIG. 7 is a schematic block diagram depicting the configuration of a base station device 300 in the embodiment.

FIG. 8 is a schematic block diagram depicting the configuration of an SC-FDMA signal receiving unit 302 in the embodiment.

FIG. 9 is a schematic block diagram depicting the configuration of an iterative processing unit 305 in the embodiment.

FIG. 10 is a graph depicting block error rate (BLER) performance in an existing example and this embodiment.

### DESCRIPTION OF EMBODIMENTS

Hereinafter, with reference to the drawings, an embodiment of the present invention will be described. Descriptions will be given by taking up control information of LTE as an example, but, if a Reed-Muller code is used, the embodiment is not limited to the control information and can also be applied to data transmission. Moreover, descriptions will be given by taking up the Reed-Muller code as an example, but the embodiment can also be applied to other codes as long as these codes are block codes.

### First Embodiment

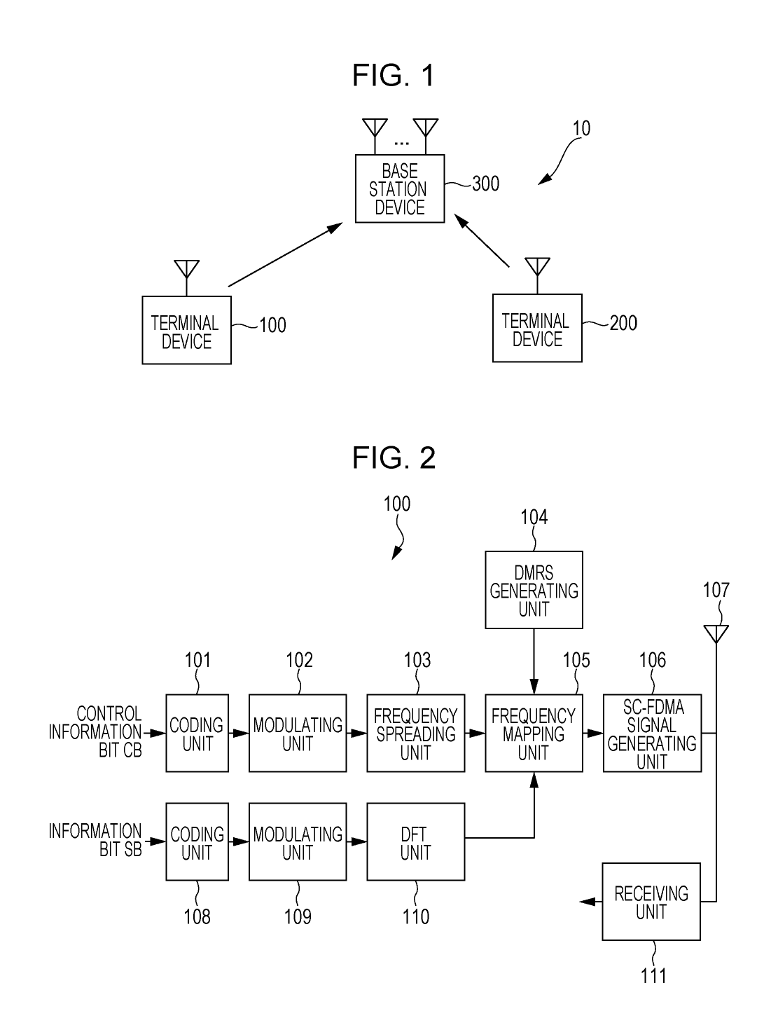

Hereinafter, a first embodiment of the present invention will be described. FIG. 1 is a schematic block diagram depicting the configuration of a radio communication system 10 in the first embodiment of the present invention. The radio communication system 10 includes terminal devices (also called mobile station devices) 100 and 200 which are transmission devices in this embodiment and a base station device 300 which is a reception device in this embodiment. Incidentally, in FIG. 1, two terminal devices are depicted, but there may be one terminal device or three or more terminal devices. The terminal devices 100 and 200 perform not only transmission of the physical uplink shared channel (PUSCH) that transmits user data, but also transmission of the physical uplink control channel (PUCCH) that transmits control information. As for the PUCCH, the terminal devices perform transmission by sharing the same resource. Here, the resource is also called a radio resource and is determined by a frequency and time. That is, performing transmission by sharing the same resource means performing transmission by using the same frequency at the same time.

FIG. 2 is a diagram depicting an example of the transmission frame configuration in this embodiment. The configuration of a transmission frame in this embodiment is similar to the PUCCH format 2 of LTE. In FIG. 2, the horizontal axis represents a frequency and a minimum unit is 1 subcarrier (called resource element (RE) in LTE). Moreover, the vertical axis represents time and a minimum unit is 1 SC-FDMA symbol. Furthermore, a hatched rectangle indicates a subcarrier by which a demodulation reference signal (DMRS) is transmitted. A solid-white rectangle indicates a subcarrier by which the PUCCH format 2 is transmitted. A central part SCH of a system band SB is a band for transmitting the PUSCH. Incidentally, also in this central part SCH, a subcarrier by which the DMRS is transmitted is present.

As described above, the PUCCH is transmitted at the edge of the system band. Incidentally, as is the case with LTE, by using different frequencies, which are used for transmission of the PUCCH, for a first slot (1st to 7th SC-FDMA symbols) and a second slot (8th to 14th SC-FDMA symbols), the frequency diversity effect is obtained. As described above, the PUCCH format 2 is transmitted by using 120 subcarriers (12×5×2) depicted as solid-white parts in FIG. 2.

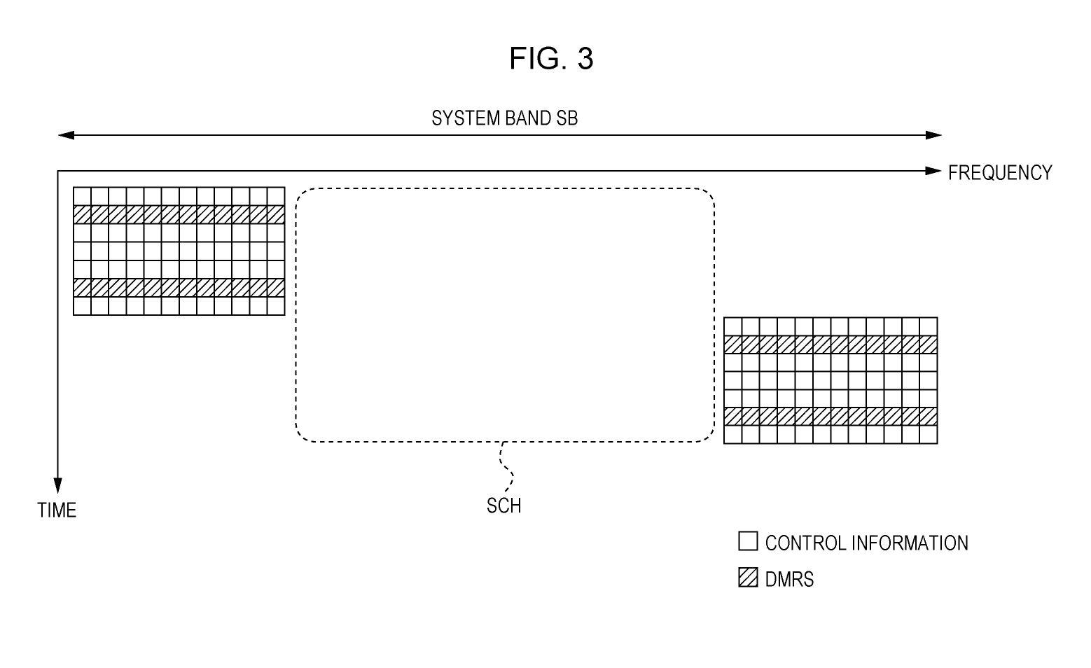

FIG. 3 is a schematic block diagram depicting the terminal device 100. Since the configuration of the terminal device 200 is similar to the configuration of the terminal device 100, the description thereof is omitted here. The terminal device 100 includes a coding unit 101, a modulating unit 102, a frequency spreading unit 103, a DMRS generating unit 104, a frequency mapping unit 105, an SC-FDMA signal generating unit 106, a transmit and receive antenna 107, a coding unit 108, a modulating unit 109, a DFT unit 110, and a receiving unit 111. Incidentally, in FIG. 3, the number of transmit antennas is 1, but a plurality of transmit antennas may be provided so as to perform transmission diversity like spatially orthogonal resource transmit diversity (SORTD) or transmit difference pieces of control information from the transmit antennas.

To the coding unit 101, a control information bit vector (N rows and 1 column) formed as an N-bit control information bit CB is input. Here, N is an integer which is smaller than or equal to 13. Moreover, the control information bit CB is a bit string indicating control information to be transmitted by the above-described PUCCH. The coding unit 101 performs coding on this vector by using a Reed-Muller code which is a kind of block code and obtains a coded bit vector formed as a 20-bit coded bit sequence. Incidentally, with a turbo code, if the number of bits to be coded is small as in this embodiment, the error correction capability is significantly reduced. However, with a block code such as the Reed-Muller code, even when the number of bits to be coded is small, it is possible to achieve high error correction capability. Therefore, it is preferable to use a block code for information with a small number of bits such as control information.

Hereinafter, a coding method using the Reed-Muller code will be described.

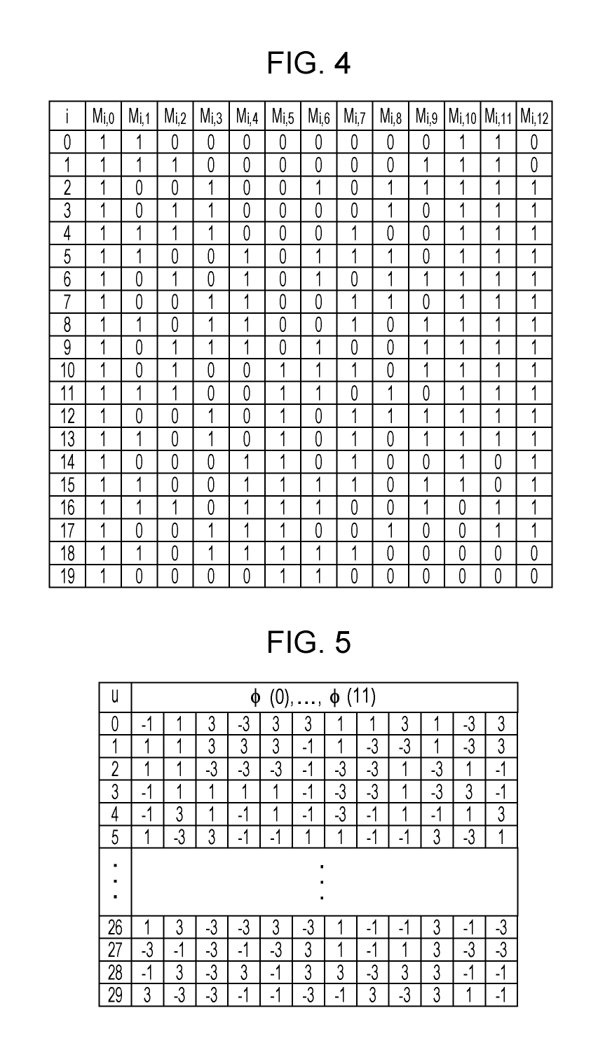

The coding unit 101 multiplies the input control information bit vector (N rows and 1 column) by a matrix with 20 rows and 13 columns, from left, in which each element is 0 or 1, the matrix depicted in FIG. 4. A table of FIG. 4 is described in Table 5.2.3.3-1 of 3GPP TS 36.212 V10.2.0. However, when N is smaller than 13, of the matrix of FIG. 4, N column (M_{i,0} to M_{i,N-1}) from the left side is cut and used. That is, multiplication is performed by using the matrix with 20 rows and N columns from left. The coding unit 101 calculates the remainder after division of each element of the vector obtained by the multiplication by 2 and uses it as a coded bit vector. The coded bit vector (20 rows and 1 column) thus obtained is input to the modulating unit 102.

The modulating unit 102 modulates the coded bit vector of the coding unit 101 to a quaternary phase shift keying (QPSK) symbol sequence. Incidentally, modulation to a binary phase shift keying (BPSK) symbol sequence may be performed, or selection from modulation to the QPSK symbol sequence and modulation to the BPSK symbol sequence may be made possible. Here, since modulation to the QPSK symbol sequence is performed, the coded bit vector (20 rows and 1 column) is converted into a symbol sequence formed of ten QPSK symbols d(0) to d(9). The symbol sequence after conversion is input to the frequency spreading unit 103.

The frequency spreading unit 103 spreads the input symbol sequence by the following expression (1) and generates a spread symbol sequence. Incidentally, the expression (1) is an expression which is used when the number of transmit antennas is 1. If the number of transmit antennas exceeds 1, the value of α is set at a different value for each transmit antenna such that r becomes orthogonal to another r between the transmit antennas; however, detailed descriptions are omitted here.

$$\begin{matrix}[ Equation 1 ] & \\ z ( {N}_{seq}^{PUCCH} \cdot n + i ) = d ( n ) \cdot {r}_{u , v}^{( α )} ( i ) \\ where & ( 1 ) \\ \{ \begin{matrix}n = 0 , 1 , … , 9 \\ i = 0 , 1 , … , {N}_{sc}^{RB} \\ {N}_{seq}^{PUCCH} = {N}_{sc}^{RB} = 12\end{matrix} & ( 2 )\end{matrix}$$

Moreover, r_{u,v}^{(α)}(n) in the expression (1) is given by the following expression (3).

[Equation 2]

r_{u,v}^{(α)}(n)=e^{jαn}r_{u,v}(n),0≦n<N_{sc}^{RB} (3)

That is, r_{u,v}^{(α)}(n) is a sequence obtained by providing, to r_{u,v}(n), phase rotation which is constant between adjacent subcarriers by a cyclic shift α which differs from terminal device to terminal device. By selecting appropriate α, it is possible to turn r_{u,v}^{(α)}(n) into an orthogonal spreading code. Here, r_{u,v}(n) is expressed as the following expression (4).

[Equation 3]

r_{u,v}(n)=e^{jφ(n)π/4},0≦n<N_{sc}^{RB} (4)

φ(n) in the expression (4) is a value depicted in FIG. 5, and the value of u in the drawing is calculated by a value broadcast from a higher layer. A table of FIG. 5 is described in Table 5.5.1.2-1 of 3GPP TS 36.211 V10.4.0.

That is, when the 10 symbols (d(0) to d(9) are input, the frequency spreading unit 103 spreads each symbol 12 times in a frequency direction and calculates a spread symbol sequence formed of 120 symbols (z(0) to z(119)). The spread symbol sequence thus calculated is input to the frequency mapping unit 105.

The DMRS generating unit 104 generates a DMRS sequence which is a known sequence in the base station device 300 and is a code sequence that is used in the demodulation reference signal (DMRS).

The frequency mapping unit 105 generates a frame by performing frequency mapping of the spread symbol sequence input from the frequency spreading unit 103, the DMRS sequence input from the DMRS generating unit 104, and a frequency signal input from the DFT unit 110, which will be described later, to the resource elements in accordance with the frame configuration.

That is, the frequency mapping unit 105 maps the 120 symbols forming the spread symbol sequence to the solid-white resource elements (the resource elements of the PUCCH) of FIG. 2. Moreover, the frequency mapping unit 105 maps the symbols forming the DMRS sequence to the diagonally shaded resource elements (the resource elements of the DMRS) of FIG. 2. Furthermore, the frequency mapping unit 105 maps the symbols forming the frequency signal to the resource elements of the central part SCH of the system band (the resource elements of the PUSCH) of FIG. 2. The frame generated in the frequency mapping unit 105 is input to the SC-FDMA signal generating unit 106.

The single career-frequency division multiple access (SC-FDMA) signal generating unit 106 converts a signal of the input frame to an SC-FDMA signal and transmits the SC-FDMA signal from the transmit and receive antenna 107.

To the coding unit 108, an information bit SB indicating user data is input.

The coding unit 108 performs error correction coding such as a low density parity check (LDPC) code or a turbo code on the input information bit SB and generates a coded bit. The modulating unit 109 modulates the coded bit generated by the coding unit 108 to a modulation symbol such as BPSK, QPSK, and quadrature amplitude modulation (16QAM). The discrete Fourier transform (DFT) unit 110 performs discrete Fourier transform on a predetermined number of modulation symbols and generates a frequency signal formed of the same number of symbols as the above-mentioned predetermined number. The frequency signal thus generated is input to the frequency mapping unit 105. The receiving unit 111 receives, via the transmit and receive antenna 107, the signal transmitted from the base station device 100.

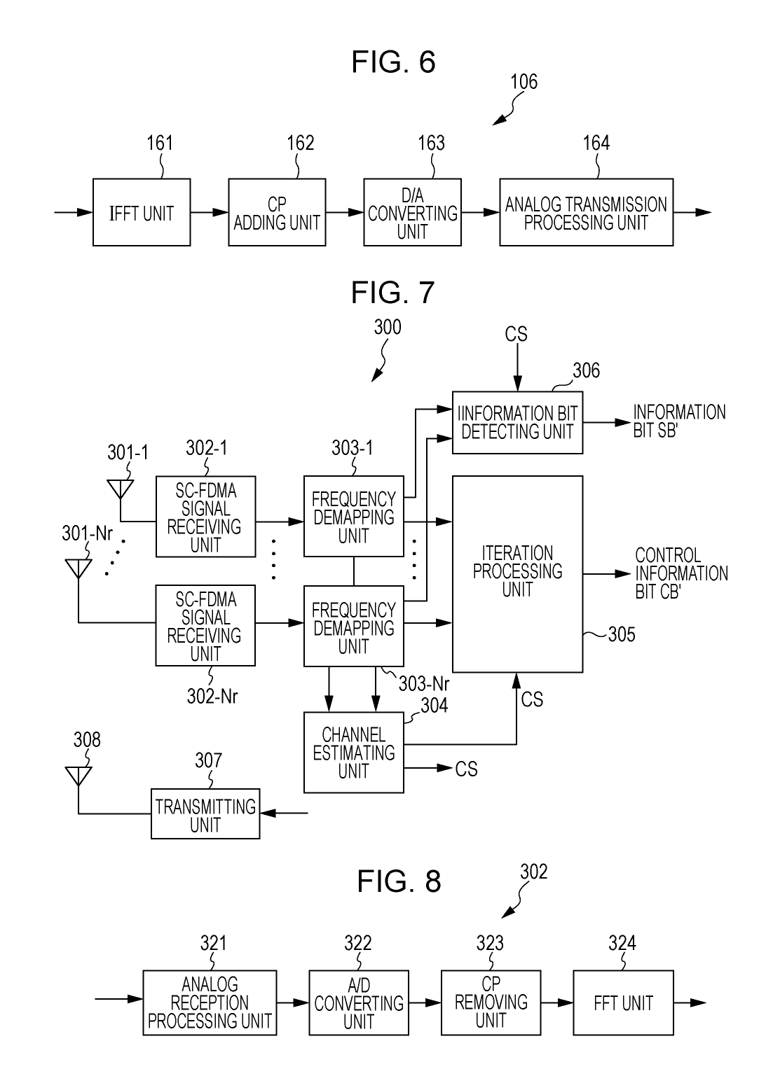

FIG. 6 is a schematic block diagram depicting the configuration of the SC-FDMA signal generating unit 106. The SC-FDMA signal generating unit 106 includes an inverse fast Fourier transform (IFFT) unit 161, a CP adding unit 162, a D/A converting unit 163, and an analog transmission processing unit 164.

A signal of the frame output from the frequency mapping unit 105 is input to the IFFT unit 161. The IFFT unit 161 performs inverse fast Fourier transform on the signal of the frame output from the frequency mapping unit 105 by using the number of points intended for the whole of the system band. For example, if the system band is formed of 2048 subcarriers, the IFFT unit 161 performs inverse fast Fourier transform by using 2048 points. The output of the IFFT unit 161 is input to the CP adding unit 162.

The cyclic prefix (CP) adding unit 162 performs processing on the output of the IFFT unit 161, the processing by which part of a rear portion of the waveform of the output of the IFFT unit 161 is copied in units of SC-FDMA symbol and is added to a front portion of the SC-FDMA symbol. The copy of part of a rear portion of the waveform, the copy which is added to a front portion of the SC-FDMA symbol, is referred to as a cyclic prefix (CP). By adding this CP, it is possible to curb the effect of a delay wave in the channel. The D/A converting unit 163 performs digital-to-analog (D/A) conversion on the output of the CP adding unit 162, thereby converting the output into an analog signal. The analog transmission processing unit 164 performs analog processing such as analog filtering, power amplification, and upconversion on the analog signal output from the D/A converting unit 163 and outputs the resultant signal to the transmit and receive antenna 107.

The signals transmitted from the transmit and receive antennas 107 of the terminal devices 100 and 200 are received by Nr receive antennas of the base station device 300 via a radio channel. FIG. 7 is a schematic block diagram depicting the configuration of the base station device 300 in this embodiment. The base station device 300 includes Nr receive antennas 301-1 to 301-Nr, Nr SC-FDMA signal receiving units 302-1 to 302-Nr, Nr frequency demapping units 303-1 to 303-Nr, a channel estimating unit 304, an iterative processing unit 305, an information bit detecting unit 306, a transmitting unit 307, and a transmit antenna 308.

The signals received by the receive antennas 301-1 to 301-Nr are input to the SC-FDMA signal receiving units 302-1 to 302-Nr, respectively. Each of the frequency demapping units 303-1 to 303-Nr separates, from the signal input thereto, a received DMRS, a received PUCCH, and a received PUSCH in accordance with the frame configuration of FIG. 2. The frequency demapping units 303-1 to 303-Nr output the received DMRSs to the channel estimating unit 304. The frequency demapping units 303-1 to 303-Nr output the received PUCCHs to the iterative processing unit 305. The frequency demapping units 303-1 to 303-Nr output the received PUSCHs to the information bit detecting unit 306.

The channel estimating unit 304 estimates a channel state by using the input received DMRSs and outputs the channel estimate CS thus obtained to the iterative processing unit 305 and the information bit detecting unit 306. The iterative processing unit 305 performs iterative processing by using the inputs from the frequency demapping units 303-1 to 303-Nr and the channel estimate CS and obtains a control information bit CB′ which is the restored control information bit CB of FIG. 2. The information bit detecting unit 306 detects an information bit SB′ corresponding to the information bit SB of FIG. 2 based on the inputs from the frequency demapping units 303-1 to 303-Nr and the channel estimate CS. The transmitting unit 307 transmits the user data, the control information, and so forth to the terminal devices 100 and 200 via the transmit antenna 308.

FIG. 8 is a schematic block diagram depicting the configuration of the SC-FDMA signal receiving unit 302. The SC-FDMA signal receiving units 302-1 to 302-Nr have the same configuration. Here, the SC-FDMA signal receiving unit 302 will be described as a representative of them. The SC-FDMA signal receiving unit 302 includes an analog reception processing unit 321, an A/D converting unit 322, a CP removing unit 323, and an FFT unit 324.

The analog reception processing unit 321 performs analog processing such as downconversion, analog filtering, and auto gain controll (AGC) on the signal input to the SC-FDMA signal receiving unit 302. The output of the analog reception processing unit 321 is input to the A/D converting unit 322. The A/D converting unit 322 performs analog-to-digital (A/D) conversion on the input signal and converts the input signal into a digital signal. The output of the A/D converting unit 322 is input to the CP removing unit 323. The CP removing unit 323 removes, from the input digital signal, the CP added on the transmission side. The output of the CP removing unit 323 is input to the FFT unit 324. The FFT unit 324 performs fast Fourier transform (FFT) on the input from the CP removing unit 323 and performs conversion from a time domain into a frequency domain. The output of the FFT unit 324 is input to a corresponding one of the frequency demapping units 303-1 to 303-Nr as the output of the SC-FDMA signal receiving unit 302.

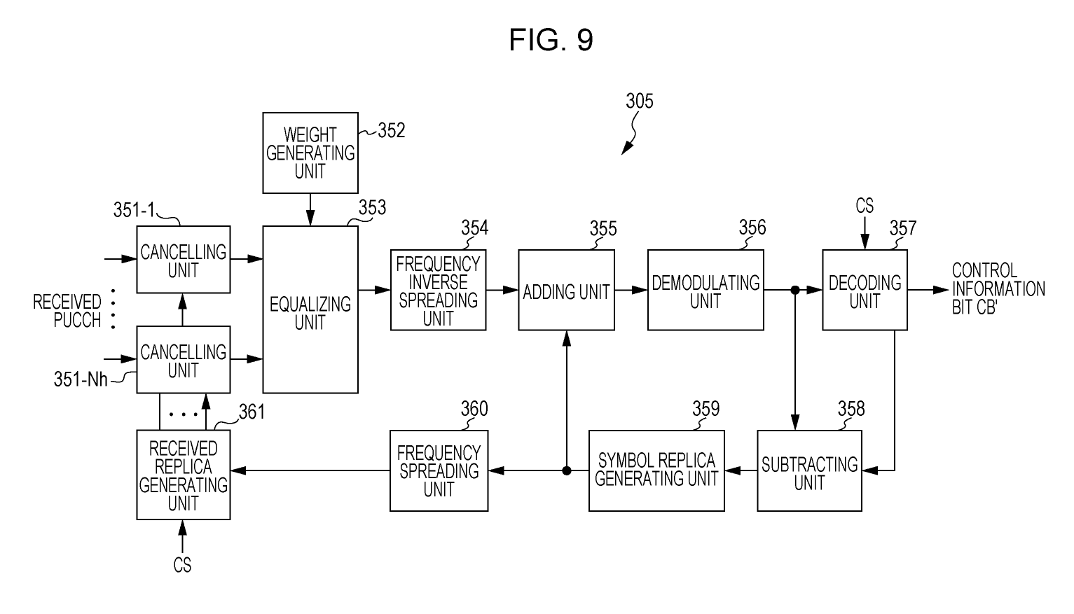

FIG. 9 is a schematic block diagram depicting the configuration of the iterative processing unit 305. In FIG. 9, the configuration for detecting a certain control information bit sequence is depicted; if the control information of the plurality of terminal devices 100 and 200 is multiplexed into the PUCCH, iterative processing corresponding to each of the terminal devices 100 and 200 is performed. The iterative processing unit 305 includes Nr cancelling units 351-1 to 351-Nr, a weight generating unit 352, an equalizing unit 353, a frequency inverse spreading unit 354, an adding unit 355, a demodulating unit 356, a decoding unit 357, a subtracting unit 358, a symbol replica generating unit 359, a frequency spreading unit 360, and a received replica generating unit 361.

The signals input from the frequency demapping units 303-1 to 303-Nr are input to the cancelling units 351-1 to 351-Nr, respectively. The cancelling units 351-1 to 351-Nr subtract the input from the received replica generating unit 361 from the inputs from the frequency demapping units 303-1 to 303-Nr and output the results to the equalizing unit 353. However, in the first iteration, the output of the received replica generating unit 361 is configured to be 0 such that none is cancelled.

The equalizing unit 353 multiplies the signals input from the cancelling units 351-1 to 351-Nr by a weight input from the weight generating unit 352 and thereby performs receive antenna combining. Here, though not depicted in the drawing, the weight generating unit 352 generates the weight based on the channel estimate CS input from the channel estimating unit 304 and the size of a symbol replica generated in the symbol replica generating unit 359. That is, the equalizing unit 353 performs equalization by multiplying the received signal by the weight for each subcarrier (resource element) and performing receive antenna combining. The equalizing unit 353 outputs the obtained signal of each subcarrier to the frequency inverse spreading unit 354.

The frequency inverse spreading unit 354 performs inverse spread on the signal output from the equalizing unit 353, the inverse spread with respect to the spread in the frequency direction which has been performed in the frequency spreading unit 103 of FIG. 2 in accordance with the expression (1). That is, the frequency inverse spreading unit 354 multiplies each subcarrier n of the output of the equalizing unit 353 by a complex conjugate of r_{u,v}^{(α)}(n) and then combines all the subcarriers. The output of the frequency inverse spreading unit 354 is input to the adding unit 355.

The adding unit 355 adds the output of the frequency inverse spreading unit 354 and the output of the symbol replica generating unit 359 and outputs the result to the demodulating unit 356. However, in the first iteration, in order to obtain 0 as the output of the symbol replica generating unit 359, the output result of the frequency inverse spreading unit 354 is output to the demodulating unit 356 as it is.

The demodulating unit 356 performs demodulation on the output of the adding unit 355 based on the modulation scheme adopted in the modulating unit 102 of FIG. 2. The demodulating unit 356 generates a log likelihood ratio (LLR) of each coded bit by this demodulation and outputs the generated coded bit LLR. The demodulation result (coded bit LLR) obtained by the demodulating unit 356 is input to the decoding unit 357 and the subtracting unit 358.

Incidentally, in this embodiment, a case in which the demodulating unit 356 outputs a bit LLR is described, but a configuration in which the demodulating unit 356 outputs a hard decision value or a soft decision value, not a bit LLR, may be adopted. In this case, the decoding unit 357 performs decoding by using the input hard decision value or soft decision value.

The decoding unit 357 (a post-decoding likelihood calculation device) decodes the control information bit and calculates a post-decoded LLR of the coded bit (a likelihood after decoding) based on the coded bit LLR input from the demodulating unit 356. Incidentally, the decoding unit 357 uses the channel estimate CS calculated by the channel estimating unit 304, in particular, dispersion σ² of the thermal noise at the time of calculation of a post-decoding LLR of the coded bit. Moreover, the decoding unit 357 controls the number of iterations of the iterative processing unit 305. Specifically, if the number of iterations for a particular received PUCCH has not reached the previously-determined maximum number, a post-decoding LLR sequence is calculated and output to the subtracting unit 358 to continue the iterative processing for the received PUCCH. On the other hand, if the number of iterations has reached the maximum number, the decoded control information bit CB′ is output and the iterative processing is ended. The method for decoding the control information bit and the method for calculating a post-decoding LLR of the coded bit will be described later.

The subtracting unit 358 subtracts the coded bit LLR sequence input from the demodulating unit 356 from the post-decoding LLR sequence input from the decoding unit 357. That is, by subtracting the LLR (pre-decoding LLR) input to the decoding unit 357 from the output LLR (post-decoding LLR) of the decoding unit 357, an external LLR which is the amount of improvement of the LLR in the decoding unit 357 is calculated. The external LLR thus calculated is input to the symbol replica generating unit 359. Incidentally, a configuration in which the subtracting unit 358 is not provided and the post-decoding LLR (also called the post LLR) calculated by the decoding unit 357 is output to the symbol replica generating unit 359 as it is may be adopted, or the subtracting unit 358 may subtract what is obtained by assigning a weight to the LLR input to the decoding unit 357 from the post-decoding LLR.

The symbol replica generating unit 359 generates a symbol replica based on the external LLR input from the subtracting unit 358. The symbol replica generating unit 359 generates a symbol replica by a method in accordance with the modulation scheme in the modulating unit 102 of FIG. 2. In this embodiment, since the modulation scheme in the modulating unit 102 is QPSK, the symbol replica generating unit 359 calculates an n-th symbol d tilde (n) in the symbol replica by using an expression (5). In the expression (5), L_{code}(m) is an external LLR of an m-th bit.

$$\begin{matrix}[ Equation 4 ] & \\ \tilde{d} ( n ) = \{ tanh ( \frac{{L}_{code} ( 2 n )}{2} ) + j tanh ( \frac{{L}_{code} ( 2 n + 1 )}{2} ) \} / \sqrt{2} & ( 5 )\end{matrix}$$

Here, n is an integer which is greater than or equal to 0. The symbol replica thus obtained is input to the frequency spreading unit 360 and the adding unit 355. As described earlier, the adding unit 355 adds the output of the frequency inverse spreading unit 354 and the output of the symbol replica generating unit 359 for each symbol. As is the case with the frequency spreading unit 103 of FIG. 2, the frequency spreading unit 360 performs frequency spread on the input symbol replica. The frequency spread signal is input to the received replica generating unit 361.

The received replica generating unit 361 generates a received replica which is a replica of the received signal in each of the receive antennas 301-1 to 301-Nr by using the frequency spread signal input from the frequency spreading unit 360 and the channel estimate CS input from the channel estimating unit 304. Here, though not depicted in FIG. 9, if the signals of the plurality of terminal devices 100 and 200 are multiplexed, the input from the frequency spreading unit 360 corresponding to each of the multiplexed terminal devices 100 and 200 is input to the received replica generating unit 361. Moreover, the channel estimating unit 307 of FIG. 7 also estimates channels between the terminal devices 100 and 200 and the receive antennas 301-1 to 301-Nr and outputs the result to the received replica generating unit 361 as a channel estimate CS. Each of the calculated received replicas is input to the cancelling units of the cancelling units 351-1 to 351-Nr corresponding to the same receive antennas 301-1 to 301-Nr.

As a result of the cancelling units 351-1 to 351-Nr subtracting the output of the received replica generating unit 361 from the outputs of the frequency demapping units 303-1 to 303-Nr, the next iteration in the iterative processing is performed. By repeating the processing in this manner, the accuracy of the symbol replica is enhanced. Incidentally, if the accuracy of the replica and channel estimation is complete, the cancelling units 351-1 to 351-Nr output only a noise component to the equalizing unit 353. Then, since a complete symbol replica is input to the adding unit 355 from the symbol replica generating unit 359, the signal without an interference component is output from the adding unit 356. That is, by repeating the processing, the accuracy of the symbol replica is enhanced and a signal with fewer interference components is output from the adding unit 356. Then, when the number of iterations has reached the maximum number, the post-decoding control information bit CB′ which is calculated by the decoding unit 357 is output as the output of the iterative processing unit 305.

Next, error correction decoding processing which is performed by the decoding unit 357 will be described. In the decoding unit 357, two types of processing: decoding of a control information bit and calculation of a post-decoding LLR of a coded bit are performed; first, decoding of a control information bit will be described. The decoding unit 357 obtains a control information bit sequence a by an expression (6) by using the coded bit LLR sequence (the received coded bit LLR sequence) input from the demodulating unit 356 as a vector y with 20 rows and 1 column.

$$\begin{matrix}[ Equation 5 ] & \\ a = arg {min}_{c} {‖ y - {x}_{c} ‖}^{2} & ( 6 )\end{matrix}$$

Here, x_{c} is a vector of a sequence (a coded bit LLR sequence) obtained by performing BPSK modulation on a coded bit string b_{c} and converting it into an LLR, and a vector b_{c} is expressed as the following expression.

[Equation 6]

b_{c}=(Ma_{c})mod 2 (7)

Here, M is a matrix depicted in FIG. 4, and X mod 2 is processing to calculate the remainder after division of X by 2. That is, the expression (7) indicates coding processing (Reed-Muller coding) in the coding unit 101 of FIG. 2. Moreover, a control information bit sequence candidate a_{c} is a vector with N rows and 1 column and a c-th pattern of all (2^{N}) patterns which an N-bit transmitted control information bit sequence can adopt. Therefore, c ranges from 0 to 2^{N}-1, and the control information bit sequence candidate a_{c} is expressed as the following expression (8). Incidentally, as described earlier, in this embodiment, N=13.

$$\begin{matrix}[ Equation 7 ] & \\ [ \begin{matrix}{a}_{0} & {a}_{1} & … & {a}_{{2}^{N} - 1}\end{matrix} ] = [ \begin{matrix}1 & 1 & 1 & … & 0 & 0 \\ 1 & 1 & 1 & … & 0 & 0 \\ ⋮ & ⋮ & ⋮ & ⋱ & ⋮ & ⋮ \\ 1 & 1 & 0 & … & 0 & 0 \\ 1 & 0 & 1 & … & 1 & 0\end{matrix} ] & ( 8 )\end{matrix}$$

That is, by using the expression (6), the decoding unit 357 outputs, of all the sequences a_{c} (c ranges from 0 to 2^{N}-1) which can be considered as the control information bit sequence, a sequence a with the minimum sum of the differences between the coded sequences a_{c} and the output of the demodulating unit 356 as the control information bit CB′.

Next, the method for calculating a post-decoding LLR of the coded bit, the method which is performed by the decoding unit 357, will be described. As described also in the coding unit 101 of FIG. 2, the relationship (coding by the Reed-Muller code) between a control information bit sequence vector a and a coded bit sequence vector b which is generated by the base station device 330 is expressed as an expression (9).

[Equation 8]

b=(Ma)mod 2 (9)

On the other hand, a post-decoding m-th coded bit LLR, L_{code}(m), which is output from the decoding unit 357 is expressed as an expression (10).

$$\begin{matrix}[ Equation 9 ] & \\ {L}_{code} ( m ) = log \frac{p ( b ( m ) = 1 \vert y )}{p ( b ( m ) = 0 \vert y )} & ( 10 )\end{matrix}$$

Moreover, based on Bayes' theorem, the following expression (11) holds; therefore, the expression (10) can be transformed as an expression (12).

$$\begin{matrix}[ Equation 10 ] & \\ \{ \begin{matrix}p ( b ( m ) = 1 \vert y ) = \frac{p ( y \vert b ( m ) = 1 ) p ( b ( m ) = 1 )}{p ( y )} \\ p ( b ( m ) = 0 \vert y ) = \frac{p ( y \vert b ( m ) = 0 ) p ( b ( m ) = 0 )}{p ( y )}\end{matrix} & ( 11 ) \\ [ Equation 11 ] & \\ {L}_{code} ( m ) = log \frac{p ( y \vert b ( m ) = 1 ) p ( b ( m ) = 1 )}{p ( y \vert b ( m ) = 0 ) p ( b ( m ) = 0 )} & ( 12 )\end{matrix}$$

Furthermore, if, in the coded bit sequence obtained by coding performed by the coding unit 101, the probability of occurrence of 0 and the probability of occurrence of 1 are equal to each other and there is no prior information in the decoding unit 357, an expression (13) holds. Therefore, the expression (12) can be transformed as an expression (14).

$$\begin{matrix}[ Equation 12 ] & \\ p ( b ( m ) = 1 ) = p ( b ( m ) = 0 ) ( = \frac{1}{2} ) & ( 13 ) \\ [ Equation 13 ] & \\ {L}_{code} ( m ) = log \frac{p ( y \vert b ( m ) = 1 )}{p ( y \vert b ( m ) = 0 )} & ( 14 )\end{matrix}$$

Here, if the assumption is made that y is a received signal in a noise (thermal noise) environment conforming to a normal distribution of the dispersion σ² (power), the following expression (15) holds. Incidentally, since the dispersion σ² is a value calculated for each of the receive antennas 301-1 to 301-Nr, when the dispersion σ² is a value that is different for each of the receive antennas 301-1 to 301-Nr, a mean value is used, for example.

$$\begin{matrix}[ Equation 14 ] & \\ p ( y \vert b ( m ) = 1 ) = {\sum }_{{b}_{c} ( m ) = 1}^{ } \frac{1}{\sqrt{2 π {σ}^{2}}} exp ( - \frac{{‖ y - {x}_{c} ‖}^{2}}{2 {σ}^{2}} ) & ( 15 )\end{matrix}$$

The above expression indicates the probability that the m-th coded bit becomes 1. However, since there are a plurality of sequences x_{c} in which the m-th coded bit becomes 1, it indicates the sum of probabilities. Since the probability that the m-th coded bit becomes 0 is also provided in the same manner, by using them, the expression (14) can be transformed as an expression (16).

$$\begin{matrix}[ Equation 15 ] & \\ \begin{matrix}{L}_{code} ( m ) = log \frac{{\sum }_{{b}_{c} ( m ) = 1}^{ } \frac{1}{\sqrt{2 π {σ}^{2}}} exp ( - \frac{{‖ y - {x}_{c} ‖}^{2}}{2 {σ}^{2}} )}{{\sum }_{{b}_{c} ( m ) = 0}^{ } \frac{1}{\sqrt{2 π {σ}^{2}}} exp ( - \frac{{‖ y - {x}_{c} ‖}^{2}}{2 {σ}^{2}} )} \\ = log \frac{{\sum }_{{b}_{c} ( m ) = 1}^{ } exp ( - \frac{{‖ y - {x}_{c} ‖}^{2}}{2 {σ}^{2}} )}{{\sum }_{{b}_{c} ( m ) = 0}^{ } exp ( - \frac{{‖ y - {x}_{c} ‖}^{2}}{2 {σ}^{2}} )}\end{matrix} & ( 16 )\end{matrix}$$

Here, since the expression (16) requires index calculation to be performed on 2^{N} sequences, the amount of operations becomes large. Thus, when approximation is performed by which, of sequences b_{c} in which the m-th coded bit becomes 1 and 0, only a sequence in which the square value of a norm is minimized is calculated, an expression (17) is obtained.

$$\begin{matrix}[ Equation 16 ] & \\ \begin{matrix}{L}_{code} ( m ) = log \frac{{max}_{{b}_{c} ( m ) = 1}^{ } exp ( - \frac{{‖ y - {x}_{c} ‖}^{2}}{2 {σ}^{2}} )}{{max}_{{b}_{c} ( m ) = 0}^{ } exp ( - \frac{{‖ y - {x}_{c} ‖}^{2}}{2 {σ}^{2}} )} \\ = \frac{{min}_{{b}_{c} ( m ) = 0}^{ } {‖ y - {x}_{c} ‖}^{2} - {min}_{{b}_{c} ( m ) = 1}^{ } {‖ y - {x}_{c} ‖}^{2} }{2 {σ}^{2}}\end{matrix} & ( 17 )\end{matrix}$$

The decoding unit 357 calculates a post-decoding LLR of the m-th coded bit by using this expression (17). That is, when calculating a post-decoding LLR of each coded bit, the decoding unit 357 uses, of the candidates for a coded bit sequence based on a block code, only a candidate whose coded bit is 1, the candidate closest to a sequence of a pre-decoding LLR, and a candidate whose coded bit is 0, the candidate closest to the sequence of the pre-decoding LLR. Specifically, the decoding unit 357 subtracts the smallest value (distance) of the distances between the coded bit LLR sequences whose m-th coded bits are 1 and a received coded bit LLR sequence y from the smallest value (distance) of the distances between the coded bit LLR sequences whose m-th coded bits are 0 and a pre-decoding bit LLR sequence y. By using this expression (17), also with the Reed-Muller code, it is possible to calculate a post-decoding coded bit LLR.

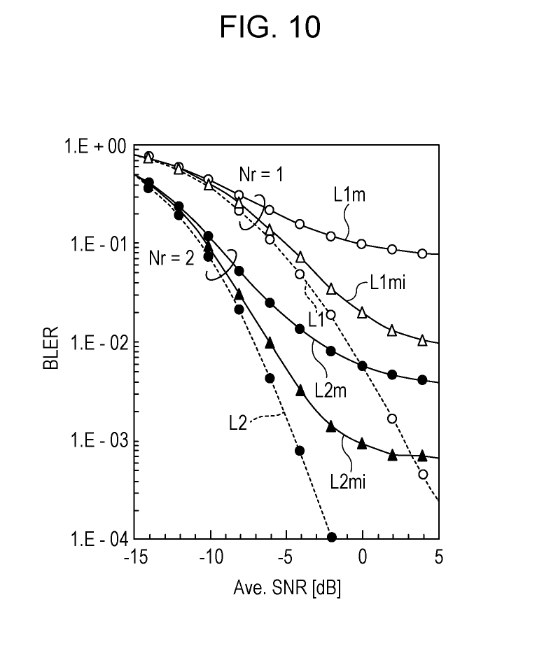

FIG. 10 is a graph depicting block error rate (BLER) performance in an existing example and this embodiment. The vertical axis represents a block error rate, and the horizontal axis represents an average signal-to-noise power ratio (SNR). The performances (codes L1, L1m, and L1mi) indicated by outline plots are performances obtained when there is one receive antenna (Nr=1), and the performances (codes L2, L2m, and L2mi) indicated by black plots are performances obtained when there are two receive antennas (Nr=2). As a simulation model, 20 MHz was adopted, the modulation scheme was QPSK, the channel model was the Extended Typical Urban model, and the travelling speed of the terminal device was set at 0 km/h. The channel estimation was set to be ideal.

The performances (L1, L1m, L2, and L2m) indicated by circular plots are performances obtained when iterative processing is not performed. Moreover, the performances (L1 and L2) indicated by circular plots and broken lines are performances obtained when the number of terminal devices is 1, and the performances (L1m and L2m) indicated by circular plots and solid lines are performance obtained when the number of multiplexor terminal devices is 12. As described above, as compared to the performance L1, the BLER of the performance L1m is high in all of the average SNRs. Likewise, as compared to the performance L2, the BLER of the performance L2m is high in all of the average SNRs. That is, when the iterative processing is not performed as in the conventional example, if the number of terminal device that performs multiplexing is increased, the BLER performance is degraded.

On the other hand, the performances (L1mi and L2mi) indicated by triangular plots are the performances obtained when the number of multiplexor terminal devices is 12, the performances of this embodiment (when iterative processing was performed ten times). As compared to the performance L1m, the BLER of the performance L1mi is low in all of the average SNRs. Likewise, as compared to the performance L2m, the BLER of the performance L2mi is low in all of the average SNRs. That is, it is confirmed that, by adopting the iterative processing, the error rate can be improved greatly.

As described above, according to this embodiment, even when the block code such as the Reed-Muller code is used as the error correction code, the decoding unit 357 calculates a post-decoding coded bit LLR. Then, since the symbol replica generating unit 359 generates a soft replica by using the calculated coded bit LLR and the cancelling units 351-1 to 351-Nr can perform cancellation in accordance with the likelihood of each coded bit, the base station device 300 can perform iterative processing. As a result, it is possible to obtain good reception quality.

### Second Embodiment

Hereinafter, a second embodiment of the present invention will be described. The configurations of each system and device in the second embodiment are the same as those of the first embodiment. However, a different method for calculating a post-decoding coded bit LLR in the decoding unit 357 is adopted. As described in the first embodiment, in calculation of an LLR in the decoding unit 357, it is assumed that noise that is normally-distributed (Gaussian-distributed) at the dispersion σ² is added to a signal.

However, when a signal of another terminal device is spatially multiplexed into a signal to be detected, in addition to a desired signal component and a noise component, a signal (a coded bit LLR) to be input to the decoding unit 357 also contains interference caused by the signal of the other terminal device. For example, if the thermal noise is small, a post-decoding LLR calculated from the expression (17) is increased. However, if the interference is significant, since the desired signal component is buried in the interference, a post-decoding LLR is supposed to be reduced. Thus, in this embodiment, a post-decoding LLR is calculated with consideration also given to the interference.

Although, in general, the interference is not normally distributed, it has been known that the interference gets closer to a normal distribution by the central limit theorem as the number of signals which will become interference (that is, the number of terminal devices that transmit the PUCCH at the same time) is increased. That is, when there are many interference terminal devices, as is the case with the thermal noise, it is possible to use an expression of a normal distribution.

When iterative equalization processing is performed, it has been known that dispersion σ_{tot,u}² of the total power of the interference (the remaining interference after cancellation) and the thermal noise, the dispersion σ_{tot,u}² used for decoding the u-th terminal device, is expressed as an expression (18) (see, for example, NPL 2).

$$\begin{matrix}[ Equation 17 ] & \\ {σ}_{tot , u}^{2} = {μ}_{u} ( 1 - {μ}_{u} ) \\ where & ( 18 ) \\ {μ}_{u} = \frac{{γ}_{u}}{1 + {δ}_{u} {γ}_{u}} & ( 19 ) \\ \{ \begin{matrix}γ = \frac{1}{12} {\sum }_{k = 0}^{11} w ( k ) {h}_{u} ( k ) \\ w ( k ) = {h}_{u}^{H} ( k ) ( {H}^{H} ( k ) Δ {H}^{H} ( k ) + {σ}_{noise}^{2} I ) \\ Δ = diag [ \begin{matrix}1 - {δ}_{0} & 1 - {δ}_{1} & … & 1 - {δ}_{U - 1}\end{matrix} ] \\ {δ}_{u} = \frac{1}{20} {\sum }_{n = 0}^{9} {\vert {\hat{d}}_{u} ( n ) \vert}^{2}\end{matrix} & ( 20 )\end{matrix}$$

Here, hᵤ(k) is a channel (a frequency response of the k-th subcarrier of the resource block to which the coded bit has been transmitted) between the u-th terminal device and the receive antennas 301-1 to 301-Nr and is a vector with Nr rows and 1 column. Here, in processing for the 1st, 3rd to 5th, and 7th OFDM symbols, the k-th subcarrier indicates the 0th to 11th subcarriers in a resource block at an edge of the system band, the edge with a lower frequency. Moreover, in processing for the 8th, 10th to 12th, and 14th OFDM symbols, the k-th subcarrier indicates the 0th to 11th subcarriers in a resource block at an edge of the system band, the edge with a higher frequency. Furthermore, H(k) is a matrix formed of coupled hᵤ(k) of U terminal devices including a terminal device to be detected and is formed of Nr rows and U columns. Moreover, σₙₒᵢₛₑ² is the power of only thermal noise, and I is a unit matrix with U rows and U columns. dᵤ hat(n) is the n-th symbol replica of the u-th terminal device, the n-th symbol replica which is output from the symbol replica generating unit 359. That is, the 0th symbol replica corresponds to the 1st OFDM symbol, the 1st symbol replica corresponds to the 3rd OFDM symbol, and the 2nd symbol replica corresponds to the 4th OFDM symbol.

As described above, in calculation of noise power at the time of decoding of a block code, by calculating the power σₜₒₜ² with consideration given not only to the power of the thermal noise but also to the interference power and using σₜₒₜ² as σ² of the expression (18), for example, it becomes possible to calculate an LLR with a high degree of accuracy.

As a result, it is possible to improve transmission performance.

Moreover, the iterative processing occupies many pieces of hardware because the iterative processing performs a large amount of computations. In each embodiment described above, the base station device 300 receives the PUCCH from the two terminal devices 100 and 200, but sometimes the PUCCHs from many terminal devices are spatially multiplexed. However, since the hardware resource of the base station device 300 is limited, the base station device 300 may not have the hardware for performing the iterative processing on all the terminal devices to be multiplexed. In such a case, a configuration may be adopted in which, when a signal of a terminal device with high reception quality is detected, the iterative processing is not performed; when a signal of a terminal device with low reception quality is detected, the iterative processing is performed. As the standard for the reception quality, the SINR (or the SNR) calculated from a reception reference signal may be used, or a terminal device that performs transmission diversity such as SORTD may be regarded as having high reception quality.

Moreover, part or all of the terminal devices 100 and 200 and the base station device 300 in each embodiment described above may be implemented as LSI which is typically an integrated circuit. The functional blocks of the terminal devices 100 and 200 and the base station device 300 may be individually implemented as a chip or part or all of the functional blocks may be integrally implemented as a chip. Furthermore, the technique of circuit integration is not limited to LSI, and circuit integration may be implemented by a dedicated circuit or a general-purpose processor. Either a hybrid or monolithic one may be adopted. Part of the functions may be implemented by hardware, and part of the functions may be implemented by software.

In addition, when a technology of circuit integration or the like that can replace LSI comes into being by the advance of the semiconductor technology, an integrated circuit implemented by that technology can also be used.

Furthermore, a program for implementing the functions of the units of the terminal devices 100 and 200 and the base station device 300 in each embodiment described above or part of the functions of the units may be recorded on a computer-readable recoding medium, and the program recorded on this recoding medium may be read and executed by a computer system to implement the units. Incidentally, the “computer system” here is assumed to include an OS and hardware such as peripheral devices.

Moreover, the “computer-readable recoding medium” refers to portable media such as a flexible disk, a magneto-optical disk, a ROM, and a CD-ROM and storage devices such as a hard disk implemented into the computer system. Furthermore, it is assumed that the “computer-readable recording medium” includes what dynamically holds a program for a short time, such as a communication wire used when a program is sent via a network such as the Internet or a communication line such as a telephone line and what holds the program for a predetermined amount of time, such as volatile memory in the computer system functioning as a server or a client in that case. Moreover, the above-described program may be provided for implementing part of the functions described above and may be what that can implement the functions described above by being combined with a program that is already recorded on the computer system.

While the embodiments of this invention have been described in detail with reference to the drawings, a specific configuration is not limited to these embodiments, and a design change and so forth within the spirit of this invention are also included.

### INDUSTRIAL APPLICABILITY

The present invention can be used in a mobile communication system using a cellular phone unit as a terminal device, but the present invention is not limited thereto.

### REFERENCE SIGNS LIST

10 radio communication system
100, 200 terminal device
101, 108 coding unit
102, 109 modulating unit
103 frequency spreading unit
104 DMRS generating unit
105 frequency mapping unit
106 SC-FDMA signal generating unit
107 transmit and receive antenna
110 DFT unit
111 receiving unit
161 IFFT unit
162 CP adding unit
163 D/A converting unit
164 analog transmission processing unit
300 base station device
301-1 to 301-Nr receive antenna
302-1 to 302-Nr SC-FDMA signal receiving unit
303-1 to 303-Nr frequency demapping unit
304 channel estimating unit
305 iterative processing unit
306 information bit detecting unit
307 transmitting unit
308 transmit antenna
321 analog reception processing unit
322 A/D converting unit
323 CP removing unit
324 FFT unit
351-1 to 351-Nr cancelling unit
352 weight generating unit
353 equalizing unit
354 frequency spreading unit
355 adding unit
356 demodulating unit
357 decoding unit
358 subtracting unit
359 symbol replica generating unit
360 frequency spreading unit
361 received replica generating unit

1. A reception device that receives a signal from a transmission device transmitting a coded bit on which error correction has been performed by a block code, the reception device comprising:
a demodulating unit that generates a demodulation result of each coded bit for the signal received from the transmission device;
a decoding unit that calculates a post-decoding likelihood of the block code based on the demodulation result;
a symbol replica generating unit that generates a symbol replica based on the post-decoding likelihood; and
a cancelling unit that cancels interference from the received signal by using the symbol replica.

2. The reception device according to claim 1, wherein
in calculating the post-decoding likelihood of each coded bit, the decoding unit uses, of candidates for a coded bit sequence based on the block code, only a candidate whose coded bit is 1, the candidate closest to a sequence of the pre-decoding likelihood, and a candidate whose coded bit is 0, the candidate closest to the sequence of the pre-decoding likelihood.

3. The reception device according to claim 1, wherein
the decoding unit uses thermal noise as noise in calculating the post-decoding likelihood of each coded bit.

4. The reception device according to claim 1, wherein
the decoding unit uses power which is a combination of thermal noise power and interference power in calculating the post-decoding likelihood of each coded bit.

5. A post-decoding likelihood calculation device that calculates a post-decoding likelihood of a coded bit coded by a block code, wherein
the post-decoding likelihood calculation device calculates the post-decoding likelihood by using, of candidates for a coded bit sequence based on the block code, only a candidate whose coded bit is 1, the candidate closest to a sequence of the pre-decoding likelihood, and a candidate whose coded bit is 0, the candidate closest to the sequence of the pre-decoding likelihood.

6. A reception method for receiving a signal from a transmission device that transmits a coded bit on which error correction has been performed by a block code, the method comprising:
a demodulation process of calculating a pre-decoding likelihood of the coded bit based on the signal received from the transmission device;
a decoding process of calculating a post-decoding likelihood of the block code based on the pre-decoding likelihood;
a symbol replica generation process of generating a symbol replica based on the post-decoding likelihood; and
a cancellation process of canceling interference from the received signal by using the symbol replica.
